(19) United States
(12) Patent Application Publication
(10) Pub. No.: US 2007/0135191 A1
(43) Pub. Date: Jun. 14, 2007

(54) Instructional game for teaching budgeting and finance management to students

(76) Inventors: Carolyn Baker, Rosemount, MN (US); Ronald Baker, Rosemount, MN (US); Heidi Jacobs, South St. Paul, MN (US)

Correspondence Address: Gary L. Huusko, Suite 600, 7300 West 147th Street, Apple Valley, MN, 55124, US

(21) Appl. No.: 11/288,595

(22) Filed: Nov. 29, 2005

(51) Int. Cl. A63F 13/00

(52) U.S. Cl. 463/1

(57) ABSTRACT

The present invention relates to a game that provides different and varying scenarios relating to budgeting wherein the student is given a Monthly Budget Sheet containing a Before Column, an After Column, and a plurality of spaces and fill-in-the blank lines for such information as Income, and for Expense Items such as Housing, Auto, Food, Clothing, Medical/Health, and Personal Expenses. Income allows the inclusion of a First Wages and a Second Wages, depending upon whether the student participant is single or married and whether the spouse earns a wage. Each Expense Item has expense estimate blank space in the Before Column and in the After Column, thus allowing the student to make changes to the Budget Sheet based upon understandings and realizations arrived at during the game. During the game, the students must draw certain instructional cards, such as Occupation Cards, Children Cards, Credit Score Cards, and Surprise Cards, which create different scenarios which the students must deal with in the budget process.

### FIELD OF INVENTION

The invention relates generally to an instructional game to teach children about basic and advanced budgeting, credit and credit scores, saving and spending, credit cards and advanced finance management.

### PRIOR ART

Games dealing with finance and money are well known, and many varied types are also well known and practiced. Most relate to an entertaining board game of some type, such as Monopoly®, Life® and the like, while others appear to be more complex, such as that taught by Kiyosaki in U.S. Pat. No. 6,106,300.

The prior art is inherently problematic in practice. One problem is that they do not represent realistic life experiences in the field of budgeting and finance management. Thus, students do not learn how everyday decisions of spending, saving, or earning affect their financial stability or their ability to enjoy life's rewards; or suffer the hardships and sacrifice that they may face when money is in short supply; or to properly care for themselves and their family.

Another problem is how to teach students the topics of budgeting, credit scores, credit cards and finance management in an interesting and entertaining way.

Still further problems include how to relate the complexities of budgeting and finance management to the everyday lives of the students and the lives they will lead as adults.

The present invention is directed towards overcoming these problems.

### DISCLOSURE OF THE INVENTION

According to the invention, a game is disclosed that provides different and varying scenarios relating to budgeting wherein the student is given a Monthly Budget Sheet containing a Before Column, an After Column, and a plurality of spaces and fill-in-the blank lines for such information as Income, and for Expense Items such as Housing, Auto, Food, Clothing, Medical/Health, and Personal Expenses. Income allows the inclusion of a First Wages and a Second Wages, depending upon whether the student participant is single or married and whether the spouse earns a wage. Each Expense Item has expense estimate blank space in the Before Column and in the After Column, thus allowing the student to make changes to the Budget Sheet based upon understandings and realizations arrived at during the game.

The Housing space includes blank lines for Apartment/House, Utilities, Telephone, Cell phone, Cable, Internet, E-mail and Total Housing related expenses, each in the Before and After Columns.

The Auto space includes blank lines for First Auto Loan, Second Auto Loan (spouse), Additional Expense, Additional Expense (spouse) and Total Auto expenses, each in the Before and After Columns.

The Clothing space includes blank lines for Adults, Children, Care/Cleaning and Total Clothing expenses, each in the Before and After Columns.

The Medical/Health space includes blank lines for Medical Bills, Dental Bills, Eye Care and Total Medical/Health expenses, each in the Before and After Columns.

The Personal space includes blank lines for Child Care, Child Expenses, School Supplies, Beauty/Barber expenses, Health Club, Tanning, Gifts, Subscriptions, Charities, Hobbies/Lessons, Cigarettes, Pets and Total Personal expenses, each in the Before and After Columns.

A space is also provided for tallying the Total Expenses, both Before and After and changes.

The Monthly Budget Sheet further includes a Balance line for subtracting the Total Expenses from the Income, a Credit Score Dollar Amount line for adding or subtracting a dollar amount according to the students credit score, a First New Balance line which is the Balance plus or minus the Credit Score, a Surprise Card line for adding or subtracting an amount based upon a real life experience that may provide additional income or result in additional expense to the student, a Second New Balance which is the First New Balance plus or minus the Surprise Card amount, and a Final Balance that shows the student how much money they have left at the end of the month, or how much they have over spent their income for the month.

The game begins with each student receiving a Monthly Budget Sheet. Each student then is given or draws an Occupation Card that contains one of a plurality of occupations the student might have in real life. Each Occupation Card lists an occupation, the number of years of education the occupation generally requires and the estimated yearly and monthly salary expected for each such occupation. Examples of Occupation Cards include an Accountant with four years of education and an annual salary of $42,500 and a monthly salary of $3,541.66; and Stay at Home with zero years of education and no annual or monthly salary. Other examples of Occupation Cards are as shown in Table 1, although many other occupations, years of education and wage levels may also be used.

TABLE 1

| | |
|---|---|
| You are an Accountant | You are an Actor |
| You have 4 years of education | You have 0 years of education |
| You make $42,500 a year | You make $30,000 a year |
| ($3,541.66 per month) | ($2,500 per month) |
| You are an Acupuncturist | You are an Administrator |
| You have 0 years of education | You have 0 years of education |
| You make $28,400 a year | You make $30,500 a year |
| ($2,366.66 per month) | ($2541.66 per month) |
| You are an Advertising | You are an Animal Trainer |
| Supervisor | You have 0 years of education |
| You have 2 years of education | You make $26,500 a year |
| You make $40,000 a year | ($2208.33 per month) |
| ($3,333.33 per month) | |
| You are an Architect | You are an Auctioneer |
| You have 4 years of education | You have 0 years of education |
| You make $50,000 a year | You make $30,400 a year |
| ($4166.66 per month) | ($2,533.33 per month) |
| You are a Bank Teller | You are a Bus Driver |
| You have 0 years of education | You have 0 years of education |
| You make $18,600 a year | You make $25,000 a year |
| ($1550.00 per month) | ($2,083.33 per month) |
| You are a Cashier | You are a Chemist |
| You have 0 years of education | You have 4 years of education |
| You make $25,000 a year | You make $48,100 a year |
| ($2083.33 per month) | ($4,008.23 per month) |
| You are a Claim Adjuster | You are a Computer Systems - |
| You have 0 years of education | Hardware |
| You make $37,300 a year | You have 2 years of education |
| ($3,108.33 per month) | You make $43,000 a year |
| | ($3,583.33 per month) |
| You are a Construction Worker | You are a Consultant |
| You have 0 years of education | You have 4 years of education |
| You make $26,000 a year | You make $40,000 a year |
| ($2166.66 per month) | ($3,333.33 per month) |
| You are in Customer Service | You are a Dental Hygienist |
| You have 0 years of education | You have 2 years of education |
| You make $28,700 a year | You make $45,700 a year |
| ($2391.66 per month) | ($3,808.33 per month) |
| You are an Electrician | You are an Engineer |
| You have 2 years of education | You have 4 years of education |
| You make $38,800 a year | You make $49,700 a year |
| ($3,166.66 per month) | ($4141.66 per month) |
| You are a Farm Machine | You are a Hospital Janitor |
| Operator | You have 0 years of education |
| You have 0 years of education | You make $23,300 a year |
| You make $25,000 a year | ($1,941.66 per month) |
| ($2,083.33 per month) | |
| You are a Hotel Clerk | You are a Librarian |
| You have 0 years of education | You have 4 years of education |
| You make $20,200 a year | You make $37,000 a year |
| ($1,683.33 per month) | ($3,083.33 per month) |
| You are a Loan Officer | You are a Marketing Manager |
| You have 4 years of education | You have 2 years of education |
| You make $37,900 a year | You make $46,000 a year |
| ($3,158.33 per month) | ($3,33.33 per month) |
| You are a Mechanic | You are a News Assistant |
| You have 1 years of education | You have 0 years of education |
| You make $35,000 a year | You make $22,300 a year |
| ($2,916.66 per month) | ($1,858.33 per month) |
| You are a Nursing Assistant | You are an Office Supervisor |
| You have 2 years of education | You have 0 years of education |
| You make $23,200 a year | You make $30,600 a year |
| ($1,933.33 per month) | ($2550.00 per month) |
| You are an Operating Room | You are a Paralegal |
| Aid | You have 2 years of education |
| You have 1 years of education | You make $27,700 a year |
| You make $30,200 a year | ($2308.33 per month) |
| ($2,516.66 per month) | |
| You are a Paramedic | You are a Physical Therapist |
| You have 2 years of education | You have 2 years of education |
| You make $30,300 a year | You make $36,100 a year |
| ($2,25.00 per month) | ($3,008.33 per month) |
| You are a Pilot | You are a Plumber |
| You have 2 years of education | You have 1 years of education |
| You make $50,000 a year | You make $47,600 a year |
| ($4,166.66 per month) | ($3,966.66 per month) |
| You are a Police Officer | You are in Public Relations |
| You have 2 years of education | You have 4 years of education |
| You make $36,200 a year | You make $40,000 a year |
| ($3,016.66 per month) | ($3,333.00 per month) |
| You are a Receptionist | You are a Sales Person |
| You have 0 years of education | You have 0 years of education |
| You make $21,100 a year | You make $35,100 a year |
| ($1,758.33 per month) | ($2,925.00 per month) |
| You are a Sales Person | You are a Security Guard |
| You have 1 years of education | You have 1 years of education |
| You make $35,700 a year | You make $29,700 a year |
| ($2,975.00 per month) | ($2,475.00 per month) |
| You are a Social Worker | You Stay At Home |
| You have 4 years of education | You have 0 years of education |
| You make $37,800 a year | You make $0.00 a year |
| ($3,150.00 per month) | ($0.00 per month) |
| You Stay at Home | You are a Teacher |
| You have 0 years of education | You have 4 years of education |
| You make $0.00 a year | You make $43,500 a year |
| ($0.00 per month) | ($3,625.00 per month) |
| You are a Veterinary | You are a Waiter/Waitress |
| Technician | You have 0 years of education |
| You have 2 years of education | You make $14,300 a year |
| You make $25,100 a year | ($1,191.66 per month) |
| ($2,091.66 per month) | |
| You are a Welder | You are a Zoologist |
| You have 0 years of education | You have 4 years of education |
| You make $32,600 a year | You make $40,00 a year |
| ($2,716.66 per month) | ($3,333.33 per month) |

A decorative symbol may also be included on each Occupation Card to represent the particular occupation listed on the Occupation Card.

The students are then given an opportunity to discuss their respective occupations with each other.

Each student is then told whether they are single or married, and if married, then each married student chooses another Occupation Card. The monthly wage from the student's Occupation Card is then put on the First Wages line, and, if married, the monthly wages from the spouse Occupation Card is put on the Second Wages line, or if single, the number zero is put on the Second Wages line.

Each student is then given or draws a Children Card that contains a number of children, from zero to three, which each student will have through the duration of the game. The number of children each student has will affect the expenses, as shown later, that the student will be required to include on his or her Monthly Budget Sheet. Each Children Card will have one of the following notations: “You have no children”, “You have one child”, “You have two children”, or “You have three children,” although the game could be played with even more children than three. A decorative symbol may also be included on each Children Card to represent the number of children.

The students are then given an opportunity to discuss their children with each other.

The game proceeds with the students entering a variety of Expense related information, all in the Before Column.

Each student then gets to decide whether they want to live in an apartment (renting) or a house (ownership), and adds to each Housing expense line in the Before Column on their respective Monthly Budget Sheets estimated expenses for each Housing expense. An embodiment of the game uses the following numbers as estimated monthly expenses: Apartment rent—one bedroom, $600; Apartment rent—two bedroom, $800; Home ownership mortgage, $1,200; Utilities—Apartment, $40; Utilities—Home, $270; Telephone, $40; Cell phone, $60 per phone; Cable—very basic, $20; Cable—basic, $40; Cable—full, $80; Internet, $30; and E-mail, $21. At each step, the student can decide whether he or she wants to incur the particular expense, such as whether they want a Cell phone, Cable television or the Internet or E-mail. Utilities, rent, mortgage and telephone are expenses each student must include on his or her Monthly Budget Sheet. For each Housing expense the student chooses not to include, he or she will put a zero on that particular expense line. The student will then total all Housing expenses and put that figure on the Total Housing expense line. During this part of the game, the students are given the opportunity to discuss the various expenses that are or may be associated with renting versus home ownership, and why any identified expense (i.e. Cell phone, Cable) may be desirable or necessary, such as a Cell phone if the student has children and needs immediate means to contact daycare or a babysitter.

Next, each student decides what type of automobile, if any, they want. Discussion also occurs between the students on the topic of differences between automobiles and their respective prices, including desires or needs for a used car or new car, or a minivan or SUV. When the student decides on the type of automobile, the associated expenses are put on the blank lines in the Auto expense space. A preferred embodiment would give the students the following expenses for their respective choices: First Auto Loan—used, $130; new, $400; Minivan, $600; and SUV, $800. If married, and the spouse requires an automobile, then the student makes choices for the spouse and enters the expenses on the Second Auto Loan line. The students are given an opportunity to discuss Additional expenses, such as insurance, gas, maintenance and repair, and include those Additional expenses on the Monthly Budget Sheet. A preferred embodiment of the game gives each student estimates for those Additional expenses, as follows: Additional expense—used, $285; new, $275; minivan, $545; and SUV, $795. Again, if married and an automobile is needed for a spouse, the student does the same calculation and entry for the spouse on the Additional expense for spouse line. The total automobile expense is then entered onto the Total Auto line.

The student then has an opportunity to discuss Food expenses, such as Groceries, lunches, dining out and the like. A preferred embodiment gives estimates for each type of Food expense, based upon the number of people in the family, number of children, and number of lunches and times dining out that the student decides upon. The following are estimates for Food expenses: Groceries, $50 per person in household; School Lunch, $40 per child; Work Lunch per adult—zero times per week, $0; two times per week, $40; and five times per week, $100. Dining out is estimated to be at $10 per person per time per week. These amounts are then entered onto the respective lines on the Monthly Budget Sheet and added together, and the sum is entered on the Total Food expense line.

The student then has an opportunity to discuss Clothing expenses, such as needs, wants and care/cleaning of clothes. A preferred embodiment gives estimates for each Clothing expense based upon the number of adults and children in the family as follows: Adult clothing, $40 per adult; Children clothing, $30 per child; Care/Cleaning, $5 per person. The Clothing expenses are then totaled and entered on the Total Clothing line.

The student is then given an opportunity to discuss Medical/Heath related expenses, such as insurance, co-pays, medicines, illnesses and injuries and the like. A preferred embodiment gives estimates for each Medical/Health expense based upon the number of persons in the family as follows: Medical Bills, $60 per person; Dental Bills, $30 per child; Eye Care, $30 per person. The Medical/Health expenses are then totaled and entered on the Total Medical/Health line.

At this part of the game, the students are given an opportunity to discuss all other types of expenses that a person or family may have, such as hobbies, sports, pets, gifts and the like. Those types of expenses are defined in the present invention as Personal expenses, and comprise such expenses as Childcare, Child Expenses, School Supplies, Beauty/Barber expenses, Health Club, Country Club, Tanning, Gifts, Subscriptions, Charities, Hobbies/Lessons, Cigarettes and Pets, although a variety of other personal expenses could be included as well. A preferred embodiment gives estimates for each such expense as follows: Childcare, $450 per child; Child Expenses, $15 per child; School Supplies, $5 per child; Beauty/Barber—basic, $10 per person; Beauty/Barber—medium expense, $20 per person; and Beauty/Barber—salon, $40 per person; Health Club, $40 per person; Country Club, $100 per person; Tanning, $25 per time; Gifts, $10 per person; Subscriptions, $10 per person; Hobbies/Lessons, $50 per hobby/lesson; Cigarettes, $300 per smoker; and Pets, $10 per pet. The students discuss the Charity expense and may enter any amount they decide. Those Personal expenses are then added and entered on the Total Personal line.

The figures entered on the Total Housing, Total Auto, Total Food, Total Clothing, Total Medical/Health, and Total Personal lines are then added and entered on the Total Expenses line of the Monthly Budget Sheet.

The student then subtracts his or her Total Expenses from his or her Total Income, and enters the sum, which could be a positive or negative number, on the Balance line of the Monthly Budget Sheet. At this point in the game, the students are allowed an opportunity to discuss their respective Balances, why a Balance may be a negative number and what factors or reasons contributed to the Balance being a negative number, as well as why a Balance would be a positive number, and the factors and reasons contributed to the Balance being a positive number.

Each student then is given or draws a Credit Score Card that contains one of three different Credit Scores and a discussion of what a Credit Score occurs. The three different Credit Score Cards are as follows: “Your Credit Score is 700 (Excellent), Add $200 to your 1^{st} ending balance;” “Your Credit Score is 600 (Good), Add $0 to your 1^{st} ending balance;” or “Your Credit Score is 500 (Needs Improvement), Subtract $200 from your 1^{st} ending balance.” Each student then follows the directions contained on their respective Credit Score Card. The students then determined whether the addition of or subtraction of the $200 to or from the respective Balances changed the Balance from a negative number to a positive number, or from a positive number to a negative number, and entered that new balance on the First New Balance line on the Monthly Budget Sheet.

The students are then given an opportunity to discuss the impact that having an excellent, good or “needs improvement” Credit Score has on their respective financial situations.

The game proceeds with each student being given or drawing a Surprise Card, each of which contains one of a plurality of life surprises, such as winning the lottery, being diagnosed with an illness and the like. Other examples of Surprise Cards are as shown in Table 2, although many other life surprises may also be used.

TABLE 2

| | |
|---|---|
| Congratulations, you have | Sorry, your doctor diagnosed you |
| received a $500.00 bonus/ | with allergies |
| dividend for being a hardworker | |
| Input $41.00 in the “Surprise | Input $15.00 in the “Surprise |
| Card” space | Card” space |
| Congratulations, you have | Sorry, you have found out you |
| finally received your child | owe child support |
| support of $100.00 a month | |
| Input $100.00 in the “Surprise | Input $100.00 in the “Surprise |
| Card” space | Card” space |
| Congratulations, you have won | Sorry, you went to the Casino and |
| $1,200.00 in the lottery | lost $1,200.00 |
| Input $100.00 in the “Surprise | Input $100.00 in the “Surprise |
| Card” space | Card” space |
| Congratulations, you will | Sorry, you owe $1500.00 in taxes |
| receive $1,500.00 back in taxes | |
| Input $125.00 in the “Surprise | Input $125.00 in the “Surprise |
| Card” space | Card” space |
| Congratulations, your friend | Sorry, you just remembered you |
| finally paid you back the | still owe your friend $1,000.00 |
| $1,000.00 they owed you | that you borrowed |
| Input $83.00 in the “Surprise | Input $83.00 in the “Surprise |
| Card” space | Card” space |

A decorative symbol may also be included on each Surprise Card to represent the particular surprise listed on the Surprise Card.

The students are then given an opportunity to discuss their respective life surprises with each other. Each Surprise Card contains either a “Congratulations” message or a “Sorry” message, each of which also instructs the student to enter a dollar figure on the Surprise card line of the Monthly Budget Sheet. The students are directed to add the dollar figure indicated on the “Congratulations” Surprise Cards to the First New Balance, and enter that sum on the Second New Balance line of the Monthly Budget Sheet. The students are also directed to subtract the dollar figure indicated on the “Sorry” Surprise Cards from the First New Balance, and enter that amount on the Second New Balance line of the Monthly Budget Sheet.

The students are then given the opportunity to discuss the effects that positive and negative life surprises have on their respective financial situations.

At this point in the game, the students are given the opportunity to go back over their respective Monthly Budget Sheets and make whatever changes they desire, entering those changes in the respective Expense lines in the After Column. The students then recalculate their respective Total Expenses, entering that amount in the After Column of the Total Expense line of the Monthly Budget Sheet and recalculate the Balance, First New Balance and Second New Balance, and to enter that final figure on the Final Balance line of the Monthly Budget Sheet.

Thus, students learn how the budgeting process works in an entertaining and interesting manner.

Another embodiment of the game would include adding expenses of looking for a job, taxes, and how to set realistic expectations for expenses that fit within one's budget income. Balancing a checkbook would also be included in this embodiment.

Yet another embodiment would be directed towards older students that would add a savings expense option, an investment expense option and a plurality of growth or loss scenarios, a credit card debt expense and instruction on how to utilize credit cards in everyday life situations, education options, a student loan expense option, variable job options, and more life seasoned Surprise Card situations.

The goal of the game is to learn how to budget, and to develop skills necessary to deal with consequences that may arise when life situations impact a household's budget.

### BRIEF DESCRIPTION OF DRAWINGS

FIG. 1 is a view of a blank Monthly Budget Sheet.

FIG. 2 is a view of a Monthly Budget Sheet with estimated expenses.

FIG. 3 shows examples of the Occupation Cards.

FIG. 4 shows examples of the Children Cards.

FIG. 5 shows examples of the Credit Score Cards.

FIG. 6 shows examples of the Surprise Cards.

### DETAILED DESCRIPTION OF DRAWINGS AND BEST MODE FOR CARRYING OUT THE INVENTION

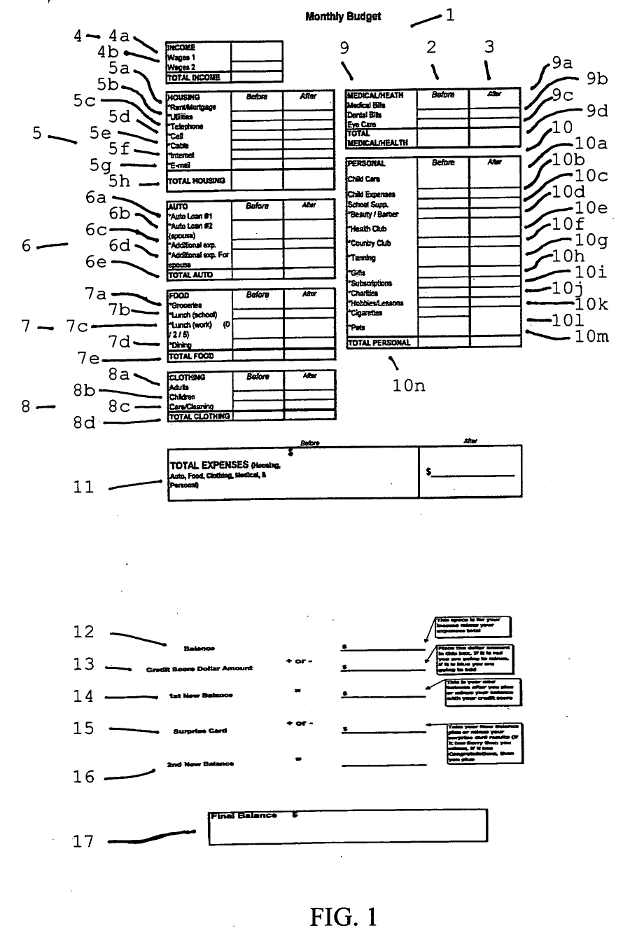

Referring now to the drawings wherein like reference numerals designate identical or corresponding parts throughout the several views, FIG. 1 shows the blank Monthly Budget Sheet 1 that each student receives at the beginning of the game. The game can be played with two or a plurality of students, although a facilitator or game leader is helpful in directing discussion. The game begins with each student receiving a Monthly Budget Sheet 1.

Each Monthly Budget Sheet 1 comprises a Before Column 2, an After Column 3, and a plurality of spaces and fill-in-the blank lines for such information as Income 4, and for Expense Items such as Housing 5, Auto 6, Food 7, Clothing 8, Medical/Health 9, and Personal Expenses 10. Income 4 allows the inclusion of a First Wages 4a and a Second Wages 4b, depending upon whether the student participant is single or married and whether the spouse earns a wage. Each Expense Item has expense estimate blank space in the Before Column 2 and in the After Column 3, thus allowing the student to make changes to the Monthly Budget Sheet 1 based upon understandings and realizations arrived at during the game.

The Housing 5 space includes blank lines for Rent/Mortgage 5a, Utilities 5b, Telephone 5c, Cell phone 5d, Cable 5e, Internet 5f, E-mail 5g and Total Housing 5h related expenses, each in the Before Column 2 and After Column 3.

The Auto 6 space includes blank lines for First Auto Loan 6a, Second Auto Loan 6b (spouse), Additional Expense 6c, Additional Expense (spouse) 6d and Total Auto 6e expenses, each in the Before Column 2 and After Column 3.

The Food 7 space includes blank lines for Groceries 7a, School Lunch 7b, Work Lunch 7c, Dining Out 7d, and Total Food 7e expenses, each in the Before Column 2 and After Column 3.

The Clothing 8 space includes blank lines for Adults 8a, Children 8b, Care/Cleaning 8c and Total Clothing 8d expenses, each in the Before Column 2 and After Column 3.

The Medical/Health 9 space includes blank lines for Medical Bills 9a, Dental Bills 9b, Eye Care 9c and Total Medical/Health 9d expenses, each in the Before Column 2 and After Column 3.

The Personal 10 space includes blank lines for Child Care 10a, Child Expenses 10b, School Supplies 10c, Beauty/Barber 10d expenses, Health Club 10e, Tanning 10f, Gifts 10g, Subscriptions 10h, Charities 10i, Hobbies/Lessons 10j, Cigarettes 10k, Pets 10l and Total Personal 10m expenses, each in the Before Column 2 and After Column 3.

A space is also provided for tallying the Total Expenses 11, both Before 2 and After 3 and changes.

The Monthly Budget Sheet 1 further includes a Balance 12 line, also referred to as a 1^{st} ending balance, for subtracting the Total Expenses 11 from the Income 4, a Credit Score Dollar Amount 13 line for adding or subtracting a dollar amount according to the students credit score, a First New Balance 14 line which is the Balance 12 plus or minus the Credit Score 13, a Surprise Card 15 line for adding or subtracting an amount based upon a real life experience that may provide additional income or result in additional expense to the student, a Second New Balance 16 which is the First New Balance 14 plus or minus the Surprise Card 15 amount, and a Final Balance 17 that shows the student how much money they have left at the end of the month, or how much they have over spent their income for the month.

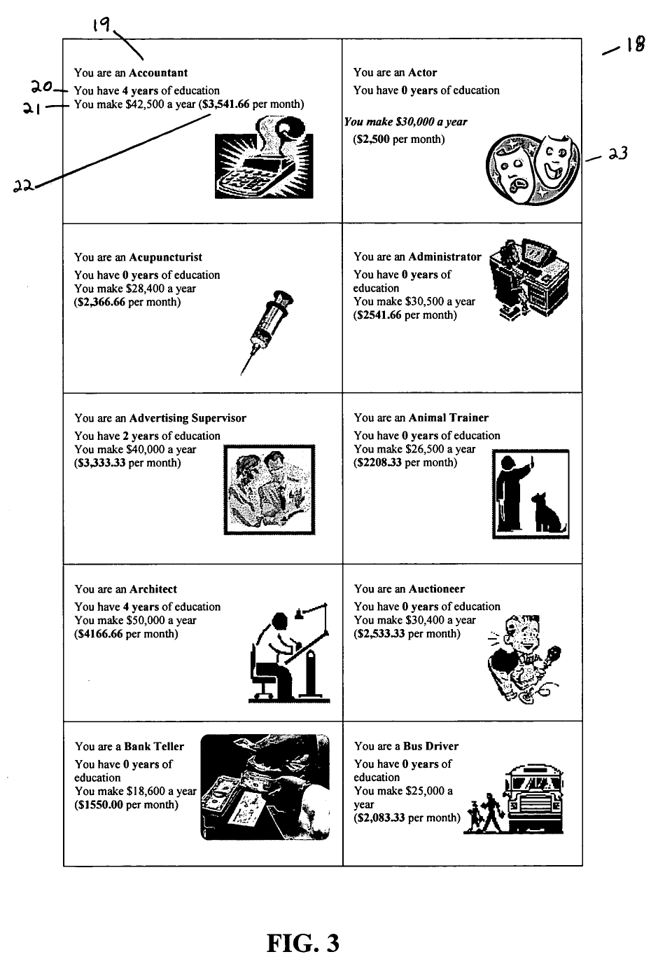

Referring now to FIG. 3, each student then is given or draws an Occupation Card 18 each containing one of a plurality of occupations the student might have in real life. Each Occupation Card 18 lists an occupation 19, the number of years of education 20 the occupation generally requires and the estimated yearly 21 and monthly 22 salary expected for each such occupation. A decorative occupational symbol 23 may also be included on each Occupation Card 18 to represent the particular occupation listed on the Occupation Card 18.

The students are then given an opportunity to discuss their respective occupations with each other.

Each student is then given an opportunity to choose to be single or married, and if married, then each married student chooses another Occupation Card 18. The monthly wage from the student's Occupation Card 18 is then put on the First Wages 4a line, and, if married, the monthly wages from the spouse Occupation Card 18 is put on the Second Wages 4b line, or if single, the number zero is put on the Second Wages 4b line.

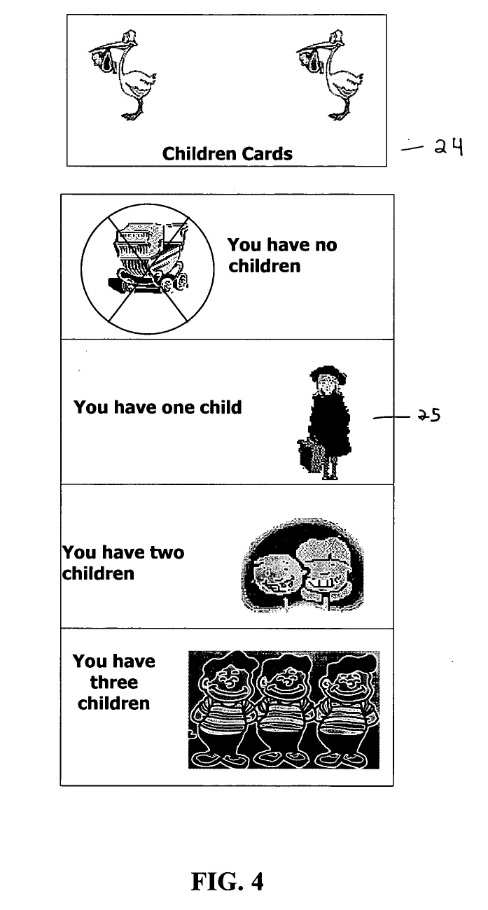

Referring now to FIG. 4, each student is then given or draws a Children Card 24 that contains a number of children, from zero to three, which each student will have through the duration of the game. The number of children each student has will affect the expenses, as shown later, that the student will be required to include on his or her Monthly Budget Sheet 1. Each Children Card 24 will have one of the following notations: “You have no children”, “You have one child”, “You have two children”, or “You have three children,” although the game could be played with even more children than three. A decorative children symbol 25 may also be included on each Children Card 24 to represent the number of children.

The students are then given an opportunity to discuss their children with each other.

The game proceeds with the students entering a variety of Expense related information, all in the Before Column 2.

Each student then gets to decide whether they want to live in an apartment (renting) or a house (ownership), and adds to each Housing 5 expense line in the Before Column 2 on their respective Monthly Budget Sheets 1 estimated expenses for each Housing 5 expense.

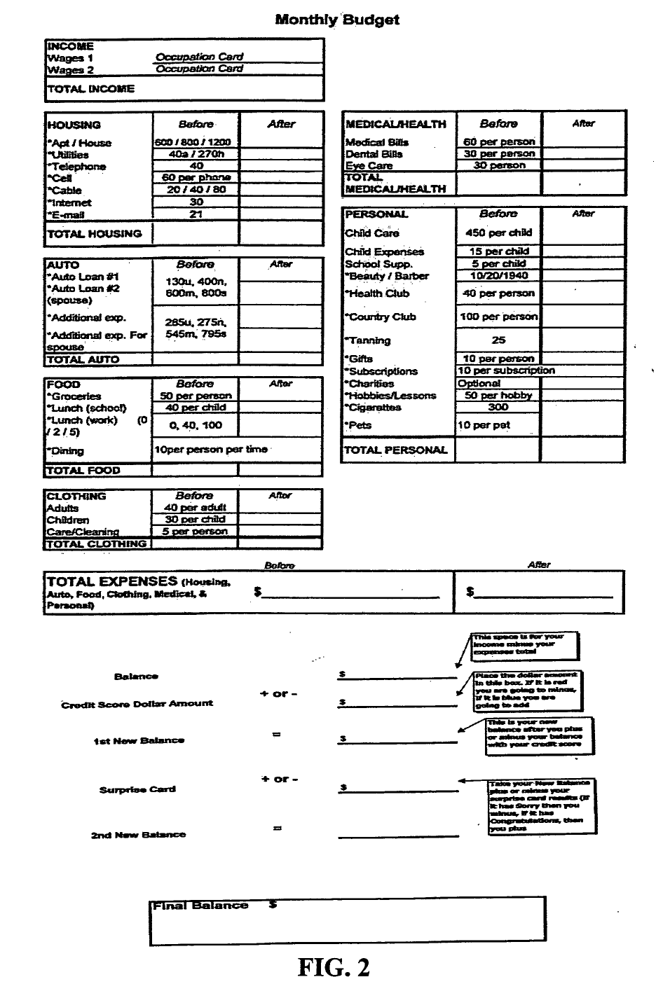

As shown in FIG. 2, an embodiment of the game uses the following numbers as estimated monthly expenses: Rent/Mortgage 5a: Apartment rent—one bedroom, $600, Apartment rent—two bedroom, $800, Home ownership mortgage, $1,200; Utilities 5b: Apartment, $40 and Home, $270; Telephone 5c, $40; Cell phone 5d, $60 per phone; Cable 5e: very basic, $20, basic, $40, and full, $80; Internet 5f, $30; and E-mail 5g, $21. At each step, the student can decide whether he or she wants to incur the particular expense, such as whether they want a Cell phone 5d, Cable television 5e or the Internet 5f or E-mail 5g. Utilities 5b, rent/mortgage 5a and telephone 5c are expenses each student must include on his or her Monthly Budget Sheet 1. For each Housing 5 expense the student chooses not to include, he or she will put a zero on that particular expense line. The student will then total all Housing 5 expenses and put that figure on the Total Housing 5h expense line. During this part of the game, the students are given the opportunity to discuss the various expenses that are or may be associated with renting versus home ownership, and why any identified expense (i.e. Cell phone 5d, Cable 5e) may be desirable or necessary, such as a Cell phone 5d if the student has children and needs immediate means to contact daycare or a babysitter.

Next, each student decides what type of automobile, if any, they want. Discussion also occurs between the students on the topic of differences between automobiles and their respective prices, including desires or needs for a used car or new car, or a minivan or SUV. When the student decides on the type of automobile, the associated expenses are put on the blank lines in the Auto 6 expense space. A preferred embodiment would give the students the following expenses for their respective choices: First Auto Loan 6a: used, $130; new, $400; Minivan, $600; and SUV, $800. If married, and the spouse requires an automobile, then the student makes choices for the spouse and enters the expenses on the Second Auto Loan 6b line. The students are given an opportunity to discuss Additional expenses 6c, such as insurance, gas, maintenance and repair, and include those Additional expenses 6c on the Monthly Budget Sheet 1.

A preferred embodiment of the game as shown in FIG. 2 gives each student estimates for those Additional expenses 6c, as follows: Additional expense 6c—used, $285; new, $275; minivan, $545; and SUV, $795. Again, if married and an automobile is needed for a spouse, the student does the same calculation and entry for the spouse on the Additional expense for spouse 6d line. The total automobile expense is then entered onto the Total Auto 6e line.

Still referring to FIG. 2, the student then has an opportunity to discuss Food 7 expenses, such as Groceries 7a, School Lunches 7b, Work Lunches 7c, Dining out 7d and the like. A preferred embodiment gives estimates for each type of Food 7 expense, based upon the number of people in the family, number of children, and number of lunches and times dining out that the student decides upon. The following are estimates for Food 7 expenses: Groceries 7a, $50 per person in household; School Lunch 7b, $40 per child; Work Lunch 7c—zero times per week, $0; two times per week, $40; and five times per week, $100. Dining out 7d is estimated to be at $10 per person per time per week. These amounts are then entered onto the respective lines on the Monthly Budget Sheet 1 and added together, and the sum is entered on the Total Food 7e expense line.

The student then has an opportunity to discuss Clothing 8 expenses, such as needs, wants and care/cleaning of clothes. A preferred embodiment gives estimates for each Clothing 8 expense based upon the number of adults and children in the family as follows: Adult clothing 8a, $40 per adult; Children clothing 8b, $30 per child; Care/Cleaning 8c, $5 per person. The Clothing 8 expenses are then totaled and entered on the Total Clothing 8d line.

The student is then given an opportunity to discuss Medical/Heath 9 related expenses, such as insurance, co-pays, medicines, illnesses and injuries and the like. A preferred embodiment gives estimates for each Medical/Health 9 expense based upon the number of persons in the family as follows: Medical Bills 9a, $60 per person; Dental Bills 9b, $30 per child; Eye Care 9c, $30 per person. The Medical/Health 9 expenses are then totaled and entered on the Total Medical/Health 9d line.

At this part of the game, the students are given an opportunity to discuss all other types of expenses that a person or family may have, such as hobbies, sports, pets, gifts and the like. Those types of expenses are defined in the present invention as Personal 10 expenses, and comprise such expenses as Childcare 10a, Child Expenses 10b, School Supplies 10c, Beauty/Barber 10d expenses, Health Club 10e, Country Club 10f, Tanning 10g, Gifts 10h, Subscriptions 10i, Charities 10j, Hobbies/Lessons 10k, Cigarettes 10l and Pets 10m, although a variety of other personal expenses could be included as well. A preferred embodiment gives estimates for each such expense as follows: Childcare 10a, $450 per child; Child Expenses 10b, $15 per child; School Supplies 10c, $5 per child; Beauty/Barber 10d: basic, $10 per person; medium expense, $20 per person; and salon, $40 per person; Health Club 10e, $40 per person; Country Club 10f, $100 per person; Tanning 10g, $25 per time; Gifts 10h, $10 per person; Subscriptions 10i, $10 per person; Hobbies/Lessons 10k, $50 per hobby/lesson; Cigarettes 10l, $300 per smoker; and Pets 10m, $10 per pet. The students discuss the Charities 10j expense and may enter any amount they decide. Those Personal 10 expenses are then added and entered on the Total Personal 10n line.

Continuing with FIG. 2, the figures entered on the Total Housing 5h, Total Auto 6e, Total Food 7e, Total Clothing 8d, Total Medical/Health 9d, and Total Personal 10n lines are then added and entered on the Total Expenses 11 line of the Monthly Budget Sheet 1.

The student then subtracts his or her Total Expenses 11 from his or her Total Income 4c, and enters the sum, which could be a positive or negative number, on the Balance 12 line of the Monthly Budget Sheet 1. At this point in the game, the students are allowed an opportunity to discuss their respective Balances 1, why a Balance 1 may be a negative number and what factors or reasons contributed to the Balance 1 being a negative number, as well as why a Balance 1 would be a positive number, and the factors and reasons contributed to the Balance 1 being a positive number.

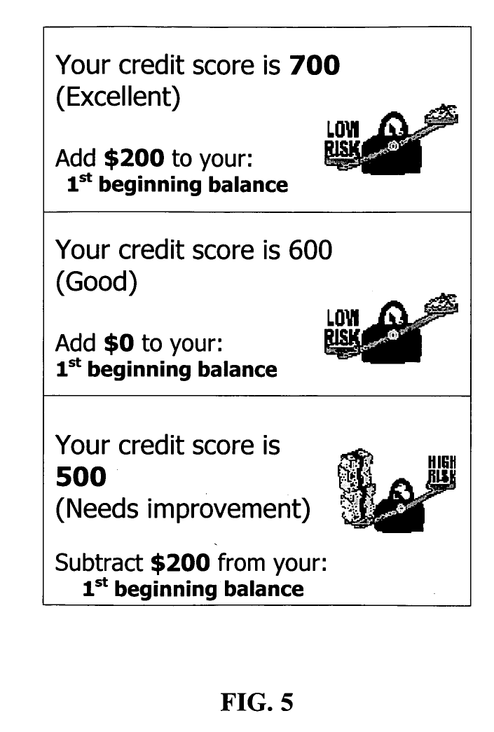

Referring now to FIG. 5, each student then is given or draws a Credit Score Card 13 that contains one of three different Credit Scores 13a and a discussion of what a Credit Score 13a is occurs. The three different Credit Score Cards 13 are as follows: “Your Credit Score is 700 (Excellent), Add $200 to your 1^{st} ending balance;” “Your Credit Score is 600 (Good), Add $0 to your 1^{st} ending balance;” or “Your Credit Score is 500 (Needs Improvement), Subtract $200 from your 1^{st} ending balance.” Each student then follows the directions contained on their respective Credit Score Card 13. The students then determined whether the addition of or subtraction of the $200 to or from the respective Balances changed the Balance 12 from a negative number to a positive number, or from a positive number to a negative number, and entered that new balance on the First New Balance 14 line on the Monthly Budget Sheet 1.

The students are then given an opportunity to discuss the impact that having an excellent, good or “needs improvement” Credit Score 13a has on their respective financial situations.

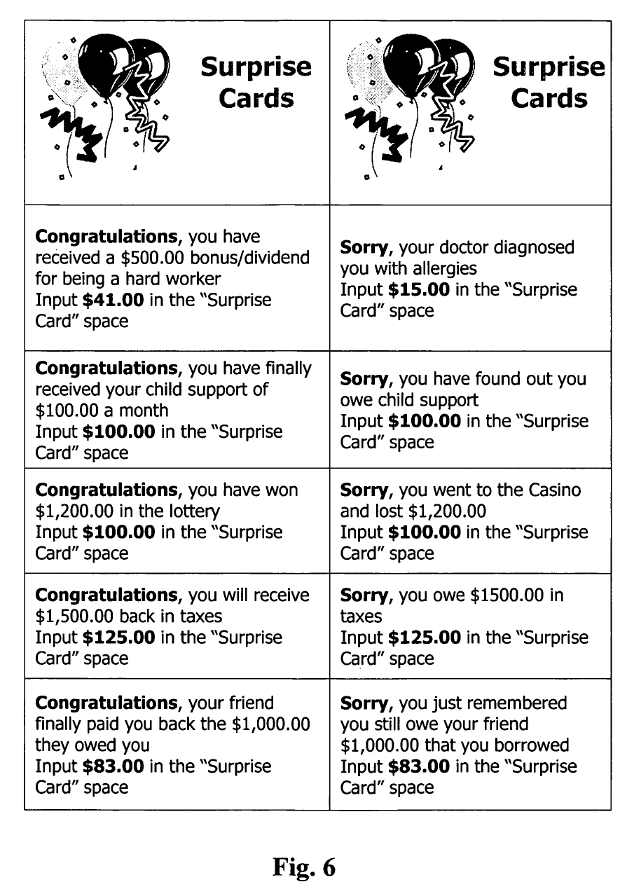

Referring now to FIG. 6, the game proceeds with each student being given or drawing a Surprise Card 15, each of which contains one of a plurality of life surprises, such as winning the lottery, being diagnosed with an illness and the like.

A decorative surprise card symbol 15a may also be included on each Surprise Card 15 to represent the particular surprise listed on the Surprise Card 15.

The students are then given an opportunity to discuss their respective life surprises with each other. Each Surprise Card 15 contains either a “Congratulations” message 15b or a “Sorry” message 15c, each of which also instructs the student to enter a dollar figure on the Surprise Card 15 line of the Monthly Budget Sheet 1. The students are directed to add the dollar figure indicated on the “Congratulations” 15b Surprise Cards 15 to the First New Balance 14, and enter that sum on the Second New Balance 16 line of the Monthly Budget Sheet 1. The students are also directed to subtract the dollar figure indicated on the “Sorry” 15c Surprise Cards 15 from the First New Balance 14, and enter that amount on the Second New Balance 16 line of the Monthly Budget Sheet 1.

The students are then given the opportunity to discuss the effects that positive and negative life surprises have on their respective financial situations.

At this point in the game, the students are given the opportunity to go back over their respective Monthly Budget Sheets 1 and make whatever changes they desire, entering those changes in the respective Expense lines in the After Column 3. The students are encouraged to come up with creative options, such as working nights to reduce child care expenses. The students then recalculate their respective Total Expenses 11, entering that amount in the After Column 3 of the Total Expense 11 line of the Monthly Budget Sheet 1 and recalculate the Balance 12, First New Balance 14 and Second New Balance 16, and to enter that final figure on the Final Balance 17 line of the Monthly Budget Sheet 1.

Thus, students learn how the budgeting process works in an entertaining and interesting manner.

We claim:

1. An instructional game for teaching budgeting and finance management to students comprising a monthly budget sheet, said monthly budget sheet comprising a Before Column, an After Column, and a plurality of spaces and fill-in-the blank lines for such information as Income, and for Expense Items such as Housing, Auto, Food, Clothing, Medical/Health, and Personal Expenses, a Total Expense, a Balance, a Credit Score Dollar Amount, a First New Balance, a Surprise Card, a Second New balance and a Final Balance,
said Income comprising a First Wages and a Second Wages,
said Housing comprising blank lines for Rent/Mortgage, Utilities, a Telephone, a Cell phone, Cable, Internet, E-mail and Total Housing related expenses, each in said Before Column and said After Column,
said Auto comprising blank lines for a First Auto Loan, a Second Auto Loan (spouse), Additional Expense, Additional Expense (spouse) and Total Auto expenses, each in said Before Column and said After Column,
said Clothing comprising blank lines for Adults, Children, Care/Cleaning and Total Clothing expenses, each in said Before Column and said After Column,
said Medical/Health comprising blank lines for Medical Bills, Dental Bills, Eye Care and Total Medical/Health expenses, each in said Before Column and said After Column,
said Personal Expenses comprises blank lines for Child Care, Child Expenses, School Supplies, Beauty/Barber expenses, Health Club, Tanning, Gifts, Subscriptions, Charities, Hobbies/Lessons, Cigarettes, Pets and Total Personal expenses, each in said Before Column and said After Column,
said Occupation Card comprising one of a plurality of occupations, a number of years of education the occupation generally requires, an estimated yearly salary and an estimated monthly salary,
said Children Card comprising a number of children,
said Credit Score Card comprising a credit score and an instruction to add or subtract money from the Balance, and
said Surprise Card comprising a life surprise, wherein
a plurality of students are given or draw the Occupation Card containing one of a plurality of occupations a student might have in real life, the number of years of education the occupation generally requires and the estimated yearly and monthly salary expected for each such occupation, after which time the students are then given an opportunity to discuss their respective occupations with each other;
each student is then told if they are single or married, and if married, then each married student chooses another Occupation Card, the monthly wage from the student's Occupation Card is then put on the First Wages line, and, if married, the monthly wages from the spouse Occupation Card is put on the Second Wages line, or if single, the number zero is put on the Second Wages line,
each student is then given or draws the Children Card that contains a number of children which each student will have through the duration of the game, and reference when entering certain expenses, the students are then given an opportunity to discuss their children with each other, the game proceeds with the students entering the expense related information for Housing, Auto, Food, Clothing, Medical/Health, and Personal Expenses, all in the Before Column,
each student then deciding whether they want to live in an apartment (renting) or a house (ownership), and adding to each Housing expense line in the Before Column on their respective Monthly Budget Sheets estimated expenses for each Housing expense, at each step, the student deciding whether he or she wants to incur the particular expense, such as whether they want a Cell phone, Cable television or the Internet or E-mail, and the students must include an expense for Utilities, rent, mortgage and telephone expenses, and for each Housing expense the student chooses not to include, he or she will put a zero on that particular expense line, the student will then total all Housing expenses and put that figure on the Total Housing expense line, again being given the opportunity to discuss the various expenses that are or may be associated with renting versus home ownership, and why any identified expense (i.e. Cell phone, Cable) may be desirable or necessary, such as the Cell phone if the student has children and needs immediate means to contact daycare or a babysitter,
each student then deciding what type of automobile, if any, they want and discussing the differences between automobiles and their respective prices, including desires or needs for a used car or a new car, or a minivan or an SUV, wherein when the student decides on the type of automobile, the associated expenses are put on the blank lines in the Auto expense space, and if married, and the spouse requires an automobile, then the student makes choices for the spouse and enters the expenses on the Second Auto Loan line;
the students then are given an opportunity to discuss Additional expenses, such as insurance, gas, maintenance and repair, and include those Additional expenses on the Monthly Budget Sheet, and again, if married and an automobile is needed for a spouse, the student does the same calculation and entry for the spouse on the Additional expense for spouse line, and the total automobile expense is then entered onto the Total Auto line;
each student then has an opportunity to discuss Food expenses, such as Groceries, School Lunches, Work Lunches and dining out based upon the number of people in the household, and those expense amounts are then entered onto the respective Food expense lines on the Monthly Budget Sheet and added together, and the sum is entered on the Total Food expense line;
each student then has an opportunity to discuss Clothing expenses, such as needs, wants and care/cleaning of clothes and enter those expenses on the corresponding Clothing expense line and then the Clothing expenses are totaled and entered on the Total Clothing line;
each student is then given an opportunity to discuss Medical/Heath related expenses, such as insurance, co-pays, medicines, illnesses and injuries and the like and enter those expenses on the corresponding Medical/Health line and then the Medical/Health expenses are totaled and entered on the Total Medical/Health line;
each student is then given an opportunity to discuss all other types of Personal expenses that a person or family may have, such as Childcare, Child Expenses, School Supplies, Beauty/Barber expenses, Health Club, Country Club, Tanning, Gifts, Subscriptions, Charities, Hobbies/Lessons, Cigarettes and Pets, those Personal expenses are then added and entered on the Total Personal line;
wherein the expense amounts entered on the Total Housing, Total Auto, Total Food, Total Clothing, Total Medical/Health, and Total Personal lines are then added and entered on the Total Expenses line of the Monthly Budget Sheet, and the student then subtracts his or her Total Expenses from his or her Total Income, and enters that sum, which could be a positive or a negative number, on the Balance line of the Monthly Budget Sheet, at which time the students are allowed an opportunity to discuss their respective Balances, why the Balance may be negative and what factors or reasons contributed to the Balance being negative, as well as why the Balance would be positive, and the factors and reasons contributed to the Balance being positive;
each student then is given or draws the Credit Score Card that contains one of three different Credit Scores and instructions, the three different Credit Scores are chosen from a group comprising: “Your Credit Score is 700 (Excellent), Add $200 to your 1^{st} ending balance;” “Your Credit Score is 600 (Good), Add $0 to your 1^{st} ending balance;” or “Your Credit Score is 500 (Needs Improvement), Subtract $200 from your 1^{st} ending balance,” each student then follows the directions contained on their respective Credit Score Card, and then determines whether the addition of or subtraction of the $200 to or from the respective Balances changed the Balance from negative to positive, or from positive to negative, and the student then enters that new balance on the First New Balance line on the Monthly Budget Sheet;
each student is then given an opportunity to discuss Credit Scores and the impact that having excellent, good or “needs improvement” Credit Scores have on their respective financial situations;
each student is then given or draws the Surprise Card, each of which contains one of a plurality of life surprises, such as winning the lottery, being diagnosed with an illness, receiving a bonus at work, receiving child support, finding out child support is owed, losing money at a casino, receiving a tax refund, owing taxes, receiving repayment of a debt, or owing money on an outstanding debt, each Surprise Card containing either a “Congratulations” message or a “Sorry” message, each of which also instructs the student to enter a dollar figure on the Surprise card line of the Monthly Budget Sheet. Wherein the students are then directed to add the dollar figure indicated on the “Congratulations” Surprise Cards to the First New Balance, and enter that sum on the Second New Balance line of the Monthly Budget Sheet and to subtract the dollar figure indicated on the “Sorry” Surprise Cards from the First New Balance, and enter that amount on the Second New Balance line of the Monthly Budget Sheet, wherein the students are then given an opportunity to discuss their respective life surprises with each other and the effects that positive and negative life surprises have on their respective financial situations;
the students then are given the opportunity to go back over their respective Monthly Budget Sheets and make whatever changes they desire, entering those changes in the respective Expense lines in the After Column, and recalculate their respective Total Expenses, entering that amount in the After Column of the Total Expense line of the Monthly Budget Sheet and recalculate the Balance, First New Balance and Second New Balance, and to enter that final figure on the Final Balance line of the Monthly Budget Sheet, thus, students learn how the budgeting process works in an entertaining and interesting manner.

2. The game of claim 1 wherein the Auto expenses comprise the First Auto Loan for the used car of $130; the new car of $400; the Minivan of $600; and the SUV of $800 and wherein the Additional expenses comprise $285 for the used car, $275 for the new car, $545 for the minivan, and $795 for the SUV; and wherein the Food expense are based upon the number of people in the family, a number of children, and a number of lunches and times dining out that the student decides upon, and further comprise $50 per person in household for Groceries, $40 per child School Lunch, and for a Work Lunch, zero times per week is $0, two times per week is $40, and five times per week is $100, and Dining out is estimated to be at $10 per person per time per week; and wherein the estimates for each Clothing expense is based upon the number of adults and children in the family and comprises for Adult clothing, $40 per adult, for Children clothing, $30 per child, and for Care/Cleaning, $5 per person; and wherein Medical/Health expense is based upon the number of persons in the family and comprises Medical Bills at $60 per person, Dental Bills at $30 per child and Eye Care at $30 per person; and wherein Personal expenses comprise Childcare at $450 per child, Child Expenses at $15 per child, School Supplies at $5 per child, Beauty/Barber basic at $10 per person, Beauty/Barber medium expense at $20 per person, and Beauty/Barber salon at $40 per person, Health Club at $40 per person, Country Club at $100 per person, Tanning at $25 per time, Gifts at $10 per person, Subscriptions at $10 per person, Hobbies/Lessons at $50 per hobby/lesson, Cigarettes at $300 per smoker, and Pets at $10 per pet and wherein the Charity expense may be any amount.

3. The game of claim 1 wherein the Children Card comprises a number of children between the numbers of zero and three, zero and three inclusive.
